(19) United States
(12) Patent Application Publication
(10) Pub. No.: US 2008/0250327 A1
(43) Pub. Date: Oct. 9, 2008

(54) Content commenting and monetization

(75) Inventors: Ying Li, Bellevue, WA (US); Tarek Najm, Kirkland, WA (US); Philip A. Lee, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/784,690

(22) Filed: Apr. 9, 2007

(51) Int. Cl. G06F 3/00

(52) U.S. Cl. 715/745

(57) ABSTRACT

A code is included in content, which code allows a user to use a comment tool to select some or all of the content, to create and submit comments, and to view previously submitted content selections and comments in conjunction with additional content. The additional content may comprise advertisements.

### BACKGROUND

Existing technology enables computer users to search and retrieve content from very many different sources over the Internet. Users take advantage of this technology to view information served by websites on nearly any topic imaginable. In some cases, groups of users having a common interest will find ways to inform each other of certain websites related to that common interest. In this way, each user can visit the website and experience the content.

“Content,” as used in this document, refers to any digital media which is capable of being electronically reproduced and which, upon reproduction, results in a sense perception. Without limitation, content may comprise text, graphics, moving and still pictures, audio, and interactive elements. By way of example and not as a limitation on the definition of “content,” content may be encoded through use of a markup language into webpages and websites (collectively referred to herein as “websites”) which are transmitted to and rendered by a browser software application operating on a general purpose computer. “Content” may also be encoded into other formats, embodied in physical media (such as magnetic or optical disks, magnetic tape, flash memory, holographic memory, and the like), and/or transmitted as digital information through any available network to be rendered, displayed, printed, and/or performed through or by media player(s) (including printers), which media player(s) may comprise an application operating on a general purpose computer or on a special purpose device. “Publishers,” as used in this document, refers broadly to any party who makes any content available through electronic media and is not limited to parties who distribute print media. A party perceiving content shall be referred to herein as a “user,” it being understood that a “user” is not required to use content for any particular purpose, but is merely one who perceives content. References are made in this document to “viewing” content; it shall be understood that “viewing” encompasses hearing, feeling, and other sense perceptions appropriate to the content's media.

Multi-party digital electronic communication has led to the development of collaborative communication technologies. Such software allows multiple parties to create, annotate, comment on, search for information in and to otherwise collaboratively work on the same document, file, and/or project. Generally though not exclusively, such software is used in the context of secure private networks and network-based user authentication.

Other collaborative digital communication technologies exist, such as “wiki” software. Wiki software generally operates on a modified webserver and allows multiple users to collaboratively create and edit websites using a markup language. The wiki webserver is generally also configured to store successive versions of the resulting websites as they are developed over time. Most wiki websites require registration of users and some require user authentication to access editing and/or creation functions, if not also to access the wiki website. Most wiki websites provide a “comment” or “discussion” tab, which provides a page in which contributors may discuss changes to the website. These discussions generally appear as a series of comments presented in the order in which they were received or posted.

A superior collaborative technology has eluded those skilled in the art, until now.

### SUMMARY

This summary is provided to introduce a selection of concepts in a simplified form that are further described below in the detailed description. This summary is not intended to identify key feature or essential features of the claimed subject matter, nor is it intended to be used to limit the scope of the claimed subject matter.

Generally stated, the invention is directed to a system for enabling a user viewing online content to select a portion of the content and to annotate the selected portion of the content with a comment. The comment is transmitted back to the serving computing system and stored in association with the selected portion of the content. During a subsequent online session, the comment may be delivered in conjunction with the content for display proximate to the selected portion of the content. In a further enhancement, an advertisement may be selected based on and delivered in conjunction with the comment.

### BRIEF DESCRIPTION OF THE DRAWINGS

FIG. 1 is an exemplary network and device diagram in and through which systems and methods consistent with the principals of the invention may be implemented.

FIG. 2 is a functional block diagram of an exemplary computing device that may be used to implement one or more embodiments of the invention.

FIG. 3 is an operational flow diagram generally illustrating steps consistent with certain aspects of the invention.

FIG. 4 is an operational flow diagram generally illustrating steps consistent with certain aspects of the invention.

FIG. 5 is a nonexclusive example of user interface consistent with a portion of the disclosure.

FIG. 6 is a nonexclusive example of user interface consistent with a portion of the disclosure.

### DETAILED DESCRIPTION OF THE DRAWINGS

The following detailed description refers to the accompanying drawings. The same reference numbers in different drawings identify the same or similar elements. The following detailed description is for the purpose of illustrating embodiments of the invention only, and other embodiments are possible without deviating from the spirit and scope of the invention, which is limited only by the appended claims.

This document discloses a collaborative digital electronic technology that allows parties to select some or all of an article of content, the “selected content,” and to comment on and/or to otherwise annotate the selected content. Comments and/or annotations, referred to hereinafter as “comments,” may themselves comprise any content (textual, graphical, auditory, etc.). Comments may, though do not necessarily have to, have a topical or subject matter relationship to the selected content. When viewing content, selected content may be distinguished and comments in relation thereto may be viewed by users. Comments may be viewed in conjunction with additional content, including advertisements. The additional content, including advertisements, may be selected based at least in part on an analysis of the selected content, the comments and/or the content.

Comments may be created by and presented through a special purpose comment tool. Comments may be searched separately, with search results leading to comments and/or to the selected content, and/or to the entire article of content which the comments are associated. Authorization to view and/or create comments in relation to an article of content may be controlled with respect to individuals and/or groups. Such individuals and/or groups may be registered and/or unregistered users with respect to either or both of the content and/or the commenting technology and users' computers may receive cookies for tracking and identification purposes. The commenting technology may be provided as a service to one or more publishers and users by a third-party, or the commenting technology may be used directly by publishers in their interactions with users. Publishers may include commenting functionality in content at least in part through the use of code included in the content.

Certain of the figures are labeled with terms associated with specific software applications or categories of software applications, such as “browser,” “webserver,” or “db,” which is an abbreviation of “database.” The labels and the following discussion use these terms and related terms such as “website” as examples and not as limitations. Equivalent functions may be provided by other software applications operating on general and/or specialty purpose devices. Thus, references in this document to a browser, a webserver, or a database should be understood to describe any software application providing similar functions, operating on suitable hardware for such software application, and provided with suitable communication facilities.

References to a network shall be understood to describe any suitable network capable of providing communication between the other components, such as but not limited to the Internet. References to “website” should be understood to describe any content (e.g., markup language documents, active scripts, dynamically assembled content, or the like) formatted for display or performance through the browser as broadly defined above, while references to steps such as a browser contacting a webserver to obtain a webpage may be replaced by equivalent steps, such as a user obtaining a DVD or other physical media or a downloaded file which contains the content.

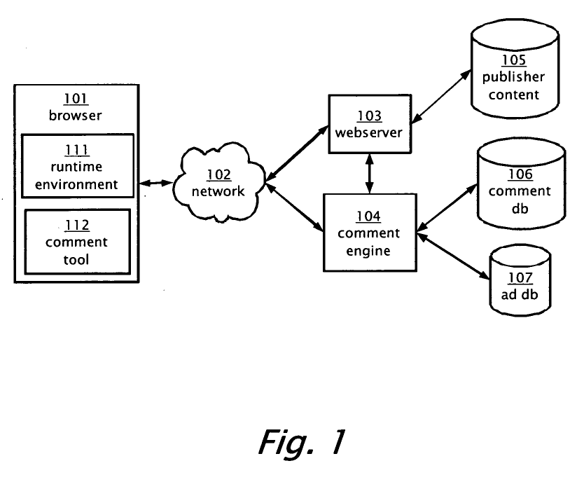

FIG. 1 is a functional block diagram generally illustrating functional components for implementing one embodiment. FIG. 1 depicts a browser 101, which may be software for rendering documents (e.g., websites) written in markup language and the like. The browser 101 and/or operating system (not shown) may include a runtime environment 111 for compiling, as necessary, and executing runtime executable code and scripts, collectively referred to herein as “runtime scripts.” The runtime environment 111 is graphically depicted as being within the browser 101, though in a given implementation it may be separate.

Also depicted in FIG. 1 is a comment tool 112. The functions comprising the comment tool 112 may be provided by application software already present in the browser 101 and/or in the computer operating the browser. The comment tool 112 may be provided before, contemporaneously with, or after the content as a runtime script. The comment tool 112 includes functions to allow a user to initiate and complete selection of content, to compose a comment which the user intends to be associated with the selected content, to submit the content selection and comments to the comment engine 104, and to view comments and other content, such as advertisements, previously associated with a website. Some or all of the functions comprising the comment tool 112 may be graphically distinguished from the browser 101, such as through application of frames of a different color and/or line weight, or some or all of such functions may be integrated into the browser 101.

FIG. 1 also depicts a webserver 103, which is a component for serving websites over the network 102. The databases depicted in FIG. 1 may be provided by one or more database servers, which servers may, for example, operate database management system software, which is known in the art. The functions implemented in the comment engine 104 may be provided by a software application written in any suitable programming language and/or the functions comprising the comment engine 104 may be provided by application software already present in one or more other software applications, such as in the browser 101, the webserver 103, and/or in a computer operating system.

As shown in FIG. 1, the browser 101 uses the network 102 to communicate with the webserver 103 and/or a comment engine 104. The browser 101 may directly communicate with either the webserver 103 and/or the comment engine 104, with further communication occurring between the webserver 103 and the comment engine 104. For example, and without limitation, the browser 101 may communicate with a webserver 103 to request content in the form of, for example, a website.

The webserver 103 may contact the comment engine 104 to obtain some or all of the content of the website, the resulting website being composed and returned to the browser 101 by the webserver 103. Alternatively, the roles of the webserver 103 and the comment engine 104 in this example may be reversed. Alternatively, in response to a content request sent by the browser 101 to either the webserver 103 and/or the comment engine 104, each of the webserver 103 and the comment engine 104 may separately return a portion of the website and comments. For example, the webserver 103 may return an un-commented version of the website while the comment engine 104 returns the comments associated with the website and other content, such as advertisements. The comment engine 104 may obtain the other content by accessing a database or other source comprising such other content, such as the advertisement database 107 depicted in FIG. 1. Access to a database or source comprising such other content may be accomplished in a variety of ways, for example by providing a reference to such other content and/or by soliciting the database or source to transmit the other content to the user.

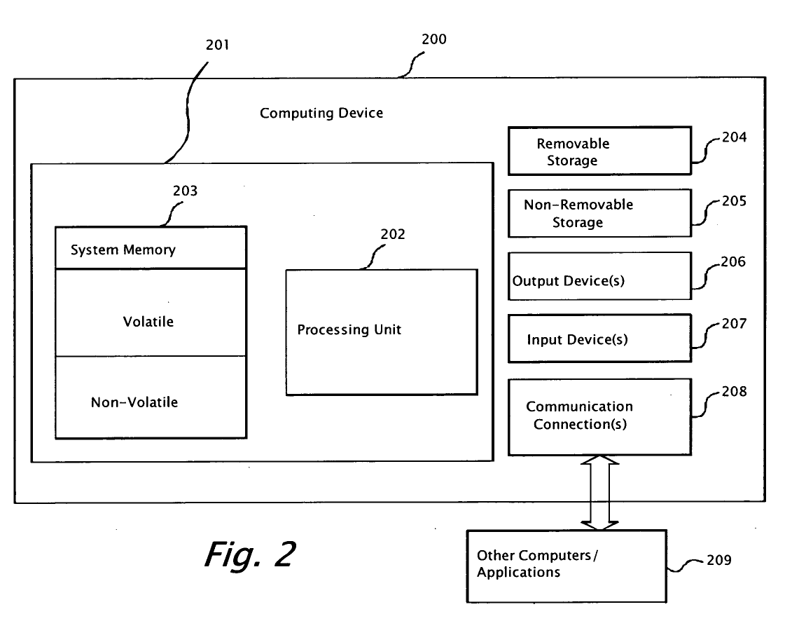

Computers operating the components depicted in FIG. 1 may be provided by suitable computing devices such as, but not limited to, the computing device graphically illustrated in FIG. 2. The functional blocks illustrated in FIG. 1 depict individual components. It should be understood that multiple such components may exist and that the depicted components may be provided by multiple physical devices logically connected to provide a virtual instance of one of the depicted units, such as, for example and without limitation, a webserver 103, comment engine 104, and/or database provided by a computing system with a distributed, multicore, multiprocessor, multicomputer, grid, and/or clustered architecture. The components depicted in FIG. 1 represent groups of functions, the functions potentially being provided within or by common or separate physical and/or logical devices.

FIG. 2 is a functional block diagram of an exemplary computing device 200 that may be used to implement one or more embodiments of the invention. The computing device 200, in one basic configuration, includes at least a processor 202 and memory 203. Depending on the exact configuration and type of computing device, memory 203 may be volatile (such as RAM), non-volatile (such as ROM, flash memory, etc.) or some combination of the two.

Additionally, device 200 may also have other features and functionality. For example, device 200 may also include additional storage (removable and/or non-removable) including, but not limited to, magnetic or optical disks or tape. Such additional storage is illustrated in FIG. 2 by removable storage 204 and non-removable storage 205. Computer storage media includes volatile and nonvolatile, removable and non-removable media implemented in any method or technology for storage of information such as computer readable instructions, data structures, program modules or other data. Memory 203, removable storage 204 and non-removable storage 205 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 200. Any such computer storage media may be part of device 200.

Computing device 200 includes one or more communication connections 208 that allow computing device 200 to communicate with one or more computers and/or applications 209. Device 200 may also have input device(s) 207 such as a keyboard, mouse, digitizer or other touch-input device, voice input device, etc. Output device(s) 206 such as a monitor, speakers, printer, PDA, mobile phone, and other types of digital display devices may also be included. These devices are well known in the art and need not be discussed at length here.

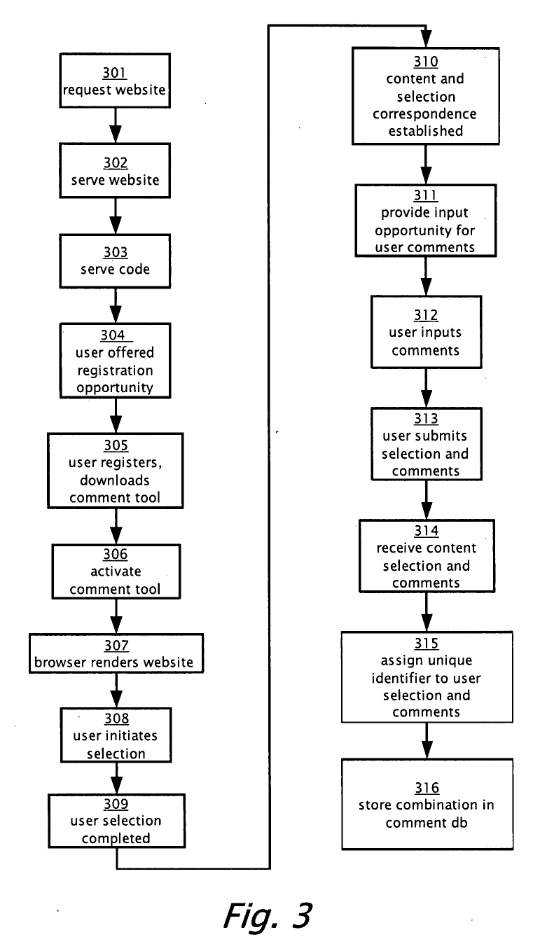

FIG. 3 depicts an operational flow diagram generally illustrating steps consistent with certain aspects of the invention. The steps are depicted as a linear progression in FIG. 3, though certain of the steps may be performed in a different order.

Referring to both FIGS. 1 and 3, a user with a browser 101 requests a website 301. A website is served 302 to the user's browser. Prior to and/or with the website, a code may be served 303, which code enables the comment tool 112. As noted above, the functions comprising the comment tool 112 may be provided by application software already present in the browser 101 and/or in the computer operating the browser, in which case the code may activate these functions; alternatively the functions comprising the comment tool 112 may be provided as a runtime script contained in or accessed through of the code. For example, and without limitation, the code may direct the browser 101 to contact the comment engine 104 and request that the comment engine transmit 303 to the browser a runtime script comprising or activating the comment tool functions 112. In an embodiment, a user may be offered a registration opportunity 304 or similar, following which the user may download the comment tool 305. Users, individually and as members of groups, may be identified and tracked through registration systems, cookies, and similar techniques. Registration and tracking of users is not required, but provides certain benefits, such as greater control over who is allowed to make and/or view comments with respect to a website.

Alternatively, and as noted above, the user may obtain content embodied in physical media and/or in a downloaded file, in which case the steps of requesting the content 301 and of having it served in response 302 are replaced by the steps involved in obtaining the physical media and/or a downloaded file. Alternatively, the user may create the content locally. Alternative to being served the code 303, the user may initiate a local application or control which achieves the same functional result of being served the code 303 (e.g. the local application or control may enable the comment tool 112).

The browser renders the website 307 and, if it is not already operational, the comment tool 112 is activated 306 and the user initiates a content selection 308. By way of example and not limitation, initiation of a content selection 308 may involve a user's utilization of a mouse, keyboard, voice command, or similar user-input device to direct a graphical representation of a pointer, cursor, selection frame or similar over or otherwise into a perceivable relation with a portion of the content. If the content involves playback of audio, visual, or audio-visual media, initiation of a selection may involve a user's utilization of a user-input device to indicate the start of the portion of the media which is to be selected, which indication may be aided by a graphical representation of the media over time, such as track-position graphic or similar.

Without limitation, an example of content selection would be a user who uses a mouse to position a pointer, clicks and holds a button on the mouse to begin selection, and, while holding the button down, drags the pointer by moving the mouse, causing a window, of an arbitrary shape such as an oval or a rectangle, to form between the original position of the pointer when first clicked and the new position of the pointer. If the selected area contains text, the selection window may conform to the text within the selected area and/or the text within the selection window may be highlighted. As further non-limiting examples, the newly formed selection window may be distinguished from unselected content by a different color palate, luminosity, and/or a boarder. In this example, releasing the mouse button may establish the boundaries of the selection window relative to the content. It may be possible to adjust the boundaries of the selection window; for example, by clicking on and dragging the boundaries and/or by repositioning the entire selection window.

The user selection is shown in FIG. 3 as being completed in step 309. In the example provided above, completion of the user selection 309 may occur upon release of the mouse and/or mouse button or it may occur after the user provides some other indication, such as a specified keyboard, mouse, or auditory input that selection has been completed 309. Completion of the user selection 309 may be associated with establishing the correspondence between the selection window and the content 310, such as a determination of the location and area of the selection window relative to the content. Completion of the user selection 309 may also cause the capture of a screen shot of the content corresponding to the area beneath the selection window. Hereinafter, a reference to the “selected content” or “content selection,” when such reference is to the selected content in isolation from the content of which it is a part, shall be understood to refer to such a screen shot, including any text, pictures, and graphics which may be part of the screen shot, and/or coordinates or a similar description of the location and area of the selection window relative to the content, as determined in step 310.

Before, after or contemporaneous with initiation of and/or completion of the user content selection, the user may be provided with an opportunity 311 to input comments, previously described as comprising text, pictures, sounds, or other content. The comment input step 312 may be facilitated by a window, field, or similar provided by the comment tool 112 for this purpose. If the comment input step 312 occurs before initiation of a user selection, the comment input step 312 may involve one or more comment input fields being opened and loaded with one or more comments which the user later associates with one or more content selections or the comment input function may only be available after a content selection is made.

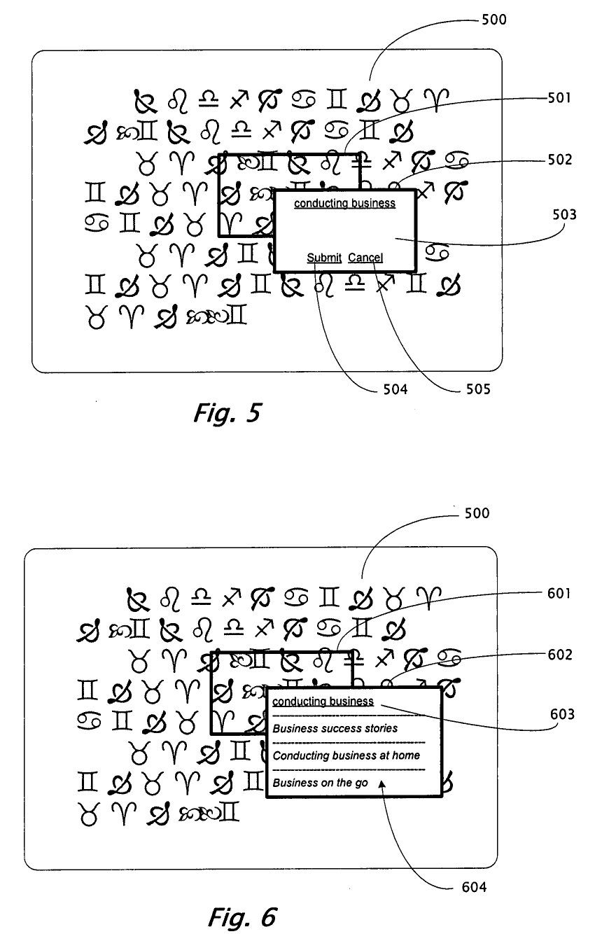

FIG. 5 presents an example of a user interface depicting content 500, a selection window 501, a comment input window 502, a comment input field 503, and controls for the comment input window, such as a “Submit” control 504 and a “Cancel” control 505. As noted above, this is a nonexclusive example of one embodiment. Other configurations of the selection window 501, the comment input window 502, the comment input field 503, and the controls 504 and 505 are conceivable and within the scope of the claimed invention. By way of further example, the comments provided in the comment input step 312 may comprise text typed into the comment input field 503 and/or files which may be dragged into the comment input field through a “drag-and-drop” procedure and/or accessed through a “find” or “browse” file location and selection feature. By way of additional nonexclusive example, the controls 504 and 505 may be replaced by other controls, may be represented by other graphical display elements, may be found and activated by “right-clicking” the comment input window 502, and/or may be provided through a textual and/or graphical menu provided elsewhere in the user interface.

Returning to FIG. 3, the user content selection is completed 309, the correspondence between the selected content and the content is established 310, the comment input opportunity is provided 311, and one or more comments are input by the user and associated with the selected content 312. The user may then submit the selected content and the comments 313. As noted above, FIG. 5 depicts a “Submit” control 504 as a nonexclusive example of how the user might indicate that selected content and comments are to be submitted 313.

As noted above with respect to the communication options which generally exist between the browser 101, the webserver 103, and the comment engine 104, the content selection and comment submission 313 may be transmitted first to either the webserver 103 and/or to the comment engine 104, with the submission being forwarded as necessary to the comment engine 104.

The submitted content selection and comments 313 are received 314 and as necessary passed between the webserver 103 and the comment engine 104. The received submission 314 is assigned a unique identifier 315 by the comment engine 104, with the received content selection, comments, and unique identifier being passed to and stored 316 in the comment database 106. In an embodiment, the comment database 106 receives, indexes, stores, and may later be used to obtain the content selection, comments, and unique identifier.

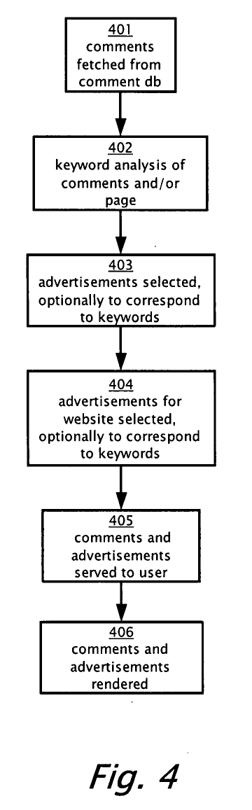

FIG. 4 depicts an operational flow diagram generally illustrating certain additional aspects of the disclosed invention. The steps in FIG. 4 may begin after the steps 301 through 307 (FIG. 3) or equivalent have occurred. Additional steps (not shown) may be included to identify and authorize the user with respect to the user's ability to view comments in relation to the website. Comments, if any, may be fetched from the comment database 401 by the comment engine 104. This step may occur at any time, such as at the point of compiling the website (not shown) prior to when it is served 302.

Keyword analysis of the comments, the content, and/or of the selected content may also be performed by the comment engine 402. This step may occur at any time, such as, for example, at a time after receipt of the comments and selected content 314 and/or at the step (not shown) of compiling the website prior to serving it to a user 301. Keyword analysis may comprise, for example, identification of and indexing of all of the words and characters. Keyword analysis may further comprise rejection of common words, such as “a” or “the.” Keyword analysis may further comprise identification of synonyms for words and/or of determination of word order probability statistics, both with respect to words not present and/or words present in the selected content, the content, and/or the comment. Keyword analysis may further comprise comparison of identified words, word groups, and/or synonyms (generally referred to as character strings) with character string rankings, such as rankings determined by the willingness of a purchaser to purchase rights relating to a character string and/or rankings of relative character string incidence in large communication corpuses, such as in communication taking place through the Internet. An example of a purchaser purchasing rights relating to a character string is when a party pays money or other consideration to a commercial information service provider and, in exchange, is allowed to display one or more advertisements to users who enter the character string (or character strings within a certain range of the character string) into, for example, a search engine maintained by the information service provider.

The product of keyword analysis may be used in many ways. For example, this product may be used to guide the selection of advertisements or other content 403 to be served 405 and/or to guide the selection of dynamic content, including advertisements, which may be part of the website 404. The advertisements or other content selected at step 403 may be obtained from the advertisement database 107, as discussed above.

At step 405, the comments and other content (which may comprise advertisements) are sent to the user. At step 406, the received comments and content are rendered for perception by the user, generally by the comment tool 112. FIG. 6 depicts an example of a user interface consistent with this disclosure, in which content is displayed 500, the selection window of a previously entered comment is displayed 601, a comment information window is displayed 602, which comment information window contains a field for a previously entered comment 603, and other content 604, which, in this example, comprises advertisements.

In different embodiments, the comment tool 112 may be perceivable at all times or may require user interaction to be perceivable. As noted above, there exist a wide variety of ways to implement a comment tool 112 in a manner consistent with the disclosed invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. From the foregoing, it will be appreciated that specific embodiments of the invention have been described herein for purposes of illustration, but that various modifications may be made without deviating from the spirit and scope of the invention. Accordingly, the invention is not limited except as by the appended claims.

What is claimed is:

1. A method for collecting and displaying comments associated with content, comprising the following steps, not necessarily in the following order:
receiving a selection of a portion of the content using a comment tool having a selection mechanism and a comment input mechanism;
receiving a comment associated with the selected portion of the content;
assigning a unique identifier to the received comment;
storing the unique identifier in association with the content;
performing a keyword analysis of the content, and/or the selected portion of the content, and/or a comment; and
delivering the content in a subsequent online session and including the comment and additional content for display proximate to the selected portion of the content.

2. The method recited in claim 1, where the additional content further comprises advertisements.

3. The method recited in claim 1, wherein the additional content is selected based at least in part on the keyword analysis.

4. The method recited in claim 1, wherein the keyword analysis is based at least in part on the purchase of rights relating to a character string.

5. The method recited in claim 1, wherein providing the comment tool further comprises providing a publisher with executable code to include in the content, the executable code being operative to enable the publisher to provide the comment tool to a user.

6. The method recited in claim 1 wherein the content selection mechanism is configured to enable a click and drag of a visually distinguishable shape into position above the content to be selected.

7. The method recited in claim 1, further comprising providing that the stored content selection(s) and comment(s) may be searched and search results link to the content with which the content selection(s) and/or comment(s) are associated.

8. The method recited in claim 1 wherein the content comprises markup language documents associated with a website.

9. The method recited in claim 1 wherein providing that content may be displayed in conjunction with at least one previously entered comment and additional content includes the step of authenticating a user and determining whether the user is authorized to view comments with respect to the content.

10. A computer system to collect and display comments associated with content, the system comprising:
a first data structure in which to store comments and user content selections;
a comment engine configured to receive a content selection and a comment related to the content selection, the content selection being a portion of a website, and configured to display at least one previously entered comment and additional content in association with the content with which the at least one previously entered comment is associated;
at least one computer processor suitable to execute instructions;
a first communication system that provides communication between the first data structure and the at least one computer processor; and
a second communication system which provides communication between the computer system and at least one remote computing system.

11. The computer system recited in claim 10 wherein the comment engine receives the comment and the content selection from a comment tool executing on the at least one remote computing system.

12. The computer system recited in claim 10 wherein the comment engine further is configured to perform keyword analysis of the content, the selected content, and/or a comment.

13. The computer system recited in claim 10 wherein the additional content comprises one or more advertisements.

14. The computer system recited in claim 10 wherein at least a portion of the comment tool is provided as a runtime executable to a user.

15. A computer-readable medium encoded with computer-executable components for collecting and displaying comments associated with content, the components comprising:
a comment database including storage for comments and unique identifiers for each of the comments;
a comment engine configured to receive an indication of a selected portion of content, the content comprising a Web page, the comment engine being further configured to received a user-provided comment, the comment engine being still further configured to store the user-provided comment in the comment database in association with a unique identifier for the user-provided comment, the comment engine being yet still further configured to retrieve the user-provided comment in response to a request to render the content on a subsequent occasion and to include the user-provided comment with the content on the subsequent occasion; and
an additional content component to provide additional content associated with the user-provided comment.

16. The computer-readable medium recited in claim 15 wherein the additional content component causes the additional content to be displayed in conjunction with the user-provided comment.

17. The computer-readable medium recited in claim 16 wherein the additional content comprises advertisements.

18. The computer-readable medium recited in claim 15 wherein the additional content component further identifies which additional content to provide based on a keyword analysis of at least one of a previously submitted comment, a content selection associated with such previously submitted comment, and/or the content with which a previously submitted comment is associated.

19. The computer-readable medium recited in claim 15 further comprising a comment tool configured to enable the selection of the content, the comment tool being deliverable as a plug-in component of a browser.

20. The computer-readable medium recited in claim 15, wherein the comment engine is further configured to associated the unique identifier with a group of users, and the comment engine is still further configured to include the user-provided comment with the content on the subsequent occasion only for other users in the group of users.
